(19) United States
(12) Patent Application Publication
(10) Pub. No.: US 2013/0259489 A1
(43) Pub. Date: Oct. 3, 2013

(54) MEMORY EXPANDING DEVICE, PORTABLE MOBILE DEVICE AND PORTABLE MOBILE SYSTEM USING THE SAME

(71) Applicant: SAMSUNG ELECTRONICS CO., LTD., Suwon-si (KR)

(72) Inventors: Jangseok CHOI, Seoul (KR); Soo-Jeong LEE, Hwaseong-si (KR)

(73) Assignee: SAMSUNG ELECTRONICS CO., LTD., Suwon-si (KR)

(21) Appl. No.: 13/834,991

(22) Filed: Mar. 15, 2013

(30) Foreign Application Priority Data
Mar. 27, 2012 (KR) 10-2012-0031155

(51) Int. Cl. G06F 13/38

(52) U.S. Cl. CPC G06F 13/38
USPC 398/141

(57) ABSTRACT

A memory expanding device for expanding a main memory of an external device connected to the memory expanding device through an optical interface.

### CROSS-REFERENCE TO RELATED APPLICATIONS

This application claims priority from Korean Patent Application No. 10-2012-0031155 filed Mar. 27, 2012, in the Korean Intellectual Property Office, the entire contents of which are hereby incorporated by reference.

### BACKGROUND

1. Field

Apparatuses and methods consistent with the exemplary embodiments relate to a memory expanding device, a portable mobile device, and a portable mobile system including the same.

2. Description of the Related Art

A data processing capacity of a system module may have been increased rapidly according to rapid technique development on a microprocessor unit and a memory chip. In this case, it may be necessary to connect a central processing unit and a main memory module in a high speed. Also, high-density connection wiring may be needed between the central processing unit and the main memory module.

A transfer speed of electric wiring connecting the central processing unit and the main memory module may be limited. Also, as the central processing unit and the main memory module are connected in a high speed, the number of memory modules capable of being connected with the central processing unit may be reduced. The reason may be that a signal integrity state is lowered due to impedance mismatch between wirings caused when an electrical signal is transferred to a module.

### SUMMARY

Exemplary embodiments provide a memory expanding device for expanding the memory of a host device.

According to an aspect of an exemplary embodiment, there is provided a memory expanding device including: an optical interface that transfers an optical signal between the memory expanding device and an external device connected to the memory expanding device through the optical interface; a memory that stores data; and a control unit that expands a main memory of the external device to include the main memory and the memory of the memory expanding deice in response to receiving a memory expansion instruction in the optical signal from the external device through the optical interface.

The interface unit may include an optical transmitter that converts an output electrical signal transferred from the control unit into an output optical signal to be transmitted to the external device; and an optical receiver configured that converts an input optical signal received from the external device into an input electrical signal to be transmitted to the control unit.

The optical transmitter may include a direction control circuit that separates the output electrical signal; a level shifter that adjusts a level of the separated output electrical signal; and an optical module that converts the level-adjusted output electrical signal into the output optical signal.

The optical receiver may include an optical module that converts the input optical signal into the input electrical signal; a level shifter that adjusts a level of the converted input electrical signal; and a direction control circuit that merges the level-adjusted input electrical signal.

The interface unit may include an optical-to-electrical converter that converts the optical signal transferred from the external device into a first electrical signal; and a signal processor that converts a signal system of the first electrical signal to generate a second electrical signal, the control unit controlling the volatile memory unit in response to the second electrical signal.

The optical-to-electrical converter may include a photo diode that converts the optical signal into an electrical signal; and a receiver integrated circuit (IC) that amplifies the electrical signal to generate the first electrical signal.

The receiver IC may include a preamplifier and a limiting amplifier.

The signal processor may include a SerDes and a multiplexer.

The memory expanding device may include a nonvolatile memory; and a nonvolatile memory control unit that controls the nonvolatile memory in response to the second electrical signal.

According to an aspect of an exemplary embodiment, there is provided a handheld mobile device including: a processor; a main memory; an optical interface that transfers an optical signal between the handheld mobile device and a memory expanding device connected to the handheld mobile device through the optical interface; and a controller that transmits to the memory expanding device a memory expansion instruction in the optical signal through the optical interface to expand the main memory of the handheld mobile device to include a memory of the memory expanding device, in response to a command of the processor; the processor controlling the memory expanding device to expand the main memory of the handheld mobile device to include the main memory and the memory of the memory expanding device.

The controller may be connected with the processor through a high-speed information processing unit.

According to an aspect of an exemplary embodiment, there is provided a handheld mobile system including: a handheld mobile device; and a memory expanding device. The memory expanding device may include an optical that transfers an optical signal between the memory expanding device and the handheld mobile device connected to the memory expanding device through the optical interface; a memory that stores data; and a control unit that expands a main memory of the external device to include the main memory and the memory of the memory expanding deice in response to receiving a memory expansion instruction in the optical signal from the external device through the optical interface.

The host interface unit may be connected with a processor of the handheld mobile device through a high-speed information processing unit.

The memory expanding device may include a nonvolatile memory; and a nonvolatile memory control unit that controls the nonvolatile memory in response to an optical signal transferred through the optical interface of the memory expanding device.

The handheld mobile device may include a host control unit that controls the volatile memory and the nonvolatile memory such that data stored at the volatile memory is swapped to the nonvolatile memory.

### BRIEF DESCRIPTION OF THE FIGURES

The above and other aspects will become apparent from the following description with reference to the following figures, wherein like reference numerals refer to like parts throughout the various figures unless otherwise specified, and wherein

FIG. 1 is a block diagram schematically illustrating a memory expanding device according to an exemplary embodiment.

FIG. 2 is a detailed block diagram illustrating a memory expanding device in FIG. 1 and the host, according to an exemplary embodiment.

FIG. 3 is a block diagram illustrating an optical transmitter of a memory expanding device in FIG. 2, according to an exemplary embodiment.

FIG. 4 is a block diagram illustrating an optical receiver of a memory expanding device in FIG. 2, according to an exemplary embodiment.

FIG. 5 is a block diagram illustrating a memory expanding device according to an exemplary embodiment.

FIG. 6 is a block diagram illustrating an optical-to-electrical converter in FIG. 5, according to an exemplary embodiment.

FIG. 7 is a block diagram illustrating a memory expanding device according to an exemplary embodiment.

FIG. 8 is a block diagram illustrating an electronic device according to an exemplary embodiment.

FIG. 9 is a block diagram illustrating an electronic device according to an exemplary embodiment.

FIG. 10 is a block diagram illustrating an electronic device according to an exemplary embodiment.

FIG. 11 is a flowchart illustrating a method of expanding memory of a host device to an exemplary embodiment.

### DETAILED DESCRIPTION OF THE EXEMPLARY EMBODIMENTS

Exemplary embodiments will be described in detail with reference to the accompanying drawings. The exemplary embodiments, however, may be embodied in various different forms, and should not be construed as being limited only to the illustrated exemplary embodiments. Rather, these exemplary embodiments are provided as examples so that this disclosure will be thorough and complete, and will fully convey the concepts of the disclosure to those skilled in the art. Accordingly, known processes, elements, and techniques are not described with respect to some of the exemplary embodiments. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular exemplary embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

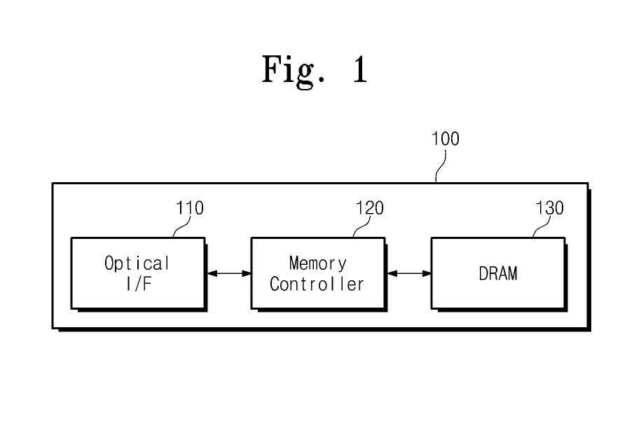

FIG. 1 is a block diagram schematically illustrating a memory expanding device according to an exemplary embodiment. Referring to FIG. 1, a memory expanding device 100 may include an optical interface 110, a memory controller 120, and a volatile memory unit 130. The memory expanding device 100 may expand a main memory device of a host (not shown) as if it is installed outside the host.

The optical interface 110 may be a signal transfer mean for transferring or receiving an optical signal. The optical interface 110 may be connected with an optical interface of the host to transmit and receive an optical signal. The optical interface 110 may be an Optical Serial Bus (OSB). However, the exemplary embodiment is not limited thereto.

The memory controller 120 may control the volatile memory unit 130. The memory controller 120 may control read and write operations of the volatile memory unit 130 based on data received from the host through the optical interface 110. The memory controller 120 may include an optical conversion module for converting an optical signal input from the optical interface 110 into an electric signal.

The volatile memory unit 130 may be a device storing data. Data may be written to or read from the volatile memory unit 130 under the control of the memory controller 120. The volatile memory unit 130 may be DRAM or SRAM. However, the exemplary embodiment is not limited thereto. The volatile memory unit 130 may include a plurality of volatile memories, each of which is controlled by the memory controller 120. The volatile memories may be connected in parallel with the memory controller 120 to be simultaneously accessed by the memory controller 120.

As described above, the memory expanding device 100 according to an exemplary embodiment may be connected with the host through the optical interface 110. The volatile memory unit 130 of the memory expanding device 100 may enable information exchange with the host to be performed in a high speed. With this configuration, the memory expanding device 100 may be used as an expanded main memory device of the host.

In addition, an optical interface of the host may be an external interface of the host. That is, the memory expanding device 100 may enable a main memory device of the host to be expanded to be removable from the host.

If expansion of a main memory device is required according to progress of a process, the host may increase a process speed using the memory expanding device 100 as a removable/external memory device. If no expansion of a main memory device is required due to completion of the process, the host may release connection with the memory expanding device 100. Thus, when expansion of a main memory device is required, the memory expanding device 100 may be connected with the host to be used as another main memory device of the host.

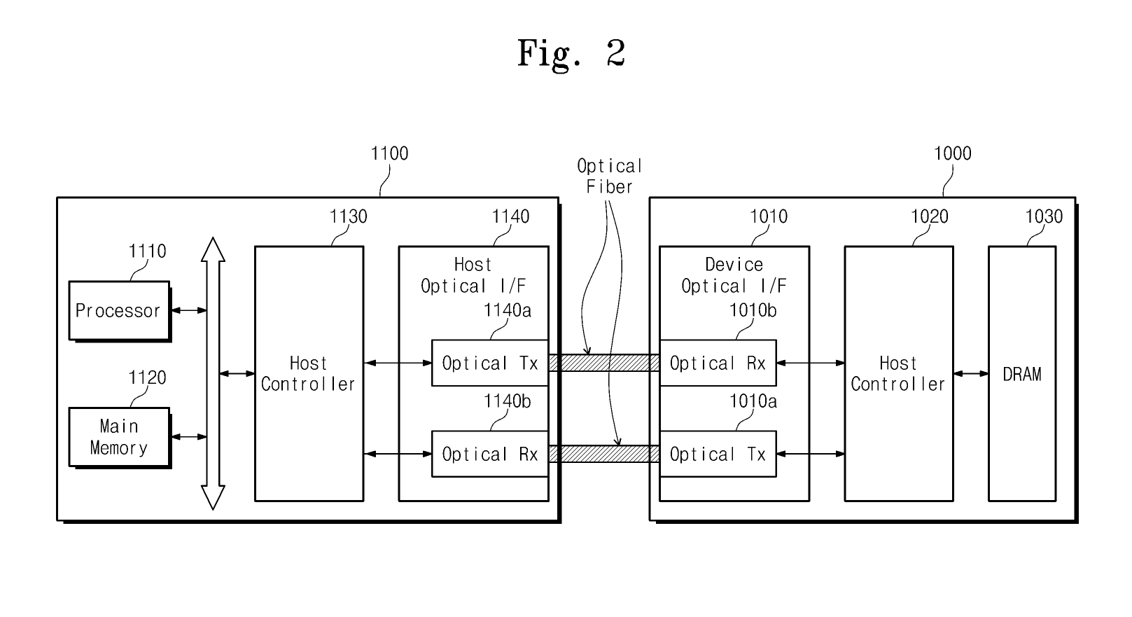

FIG. 2 is a detailed block diagram illustrating a memory expanding device in FIG. 1 and the host. Referring to FIG. 2, a host 1100 and a memory expanding device 1000 may be connected by an Optical Serial Bus (OSB).

The host 1100 may include a processor 1110, a main memory 1120, a host controller 1130, and a host optical interface 1140.

The processor 1110 may be a processing device performing various computing functions of the host 1100. The processor 1100 may be a microprocessor unit (MPU) or a central processing unit (CPU). The processor 1110 may be connected to the main memory 1120 and the host controller 1130 through a bus.

The main memory 1120 may be used as a main memory of the host 1100. Data may be read from or written to the main memory 1120 under the control of the processor 1110.

The host controller 1130 may control the memory expanding device 1000 in response to the processor 1110. If a space of the main memory 1120 is insufficient, the processor 1110 may secure a main memory space of a host system by controlling the memory expanding device 1000 through the host controller 1130. The host controller 1130 may provide the host optical interface 1140 with control signals for controlling the memory expanding device 1000, address signals, and input data signals.

The host optical interface 1140 may transfer a data input from the host controller 1130 to the memory expanding device 1000 in an optical signal format. Also, the host optical interface 1140 may transfer a data input from the memory expanding device 1000 to the host controller 1130 in an electrical signal format.

The host optical interface 1140 may include an optical transmitter 1140a and an optical receiver 1140b. The optical transmitter 1140a may convert the data input from the host controller 1130 into an optical signal to transfer it to the memory expanding device 1000. The optical receiver 1140b may convert an optical signal transferred from the memory expanding device 1000 into an electrical signal to transfer it to the host controller 1130.

A device optical interface 1010 of the memory expanding device 1000 may include an optical transmitter 1010a and an optical receiver 1010b. The device optical interface 1010 may have the same configuration and operation as the host optical interface 1140. The optical transmitter 1010a may convert a data input from a memory controller 1020 into the optical signal to transfer it to the host 1100. The optical receiver 1010b may convert the optical signal transferred from the host 1100 into an electrical signal to transfer it to the memory controller 1020.

The host optical interface 1140 may be optically connected with the device optical interface 1010. In example embodiments, the host optical interface 1140 may be connected with the device optical interface 1010 through an optical fiber. However, the exemplary embodiment is not limited thereto. For example, the host optical interface 1140 may be connected with the device optical interface 1010 through wireless optical communication.

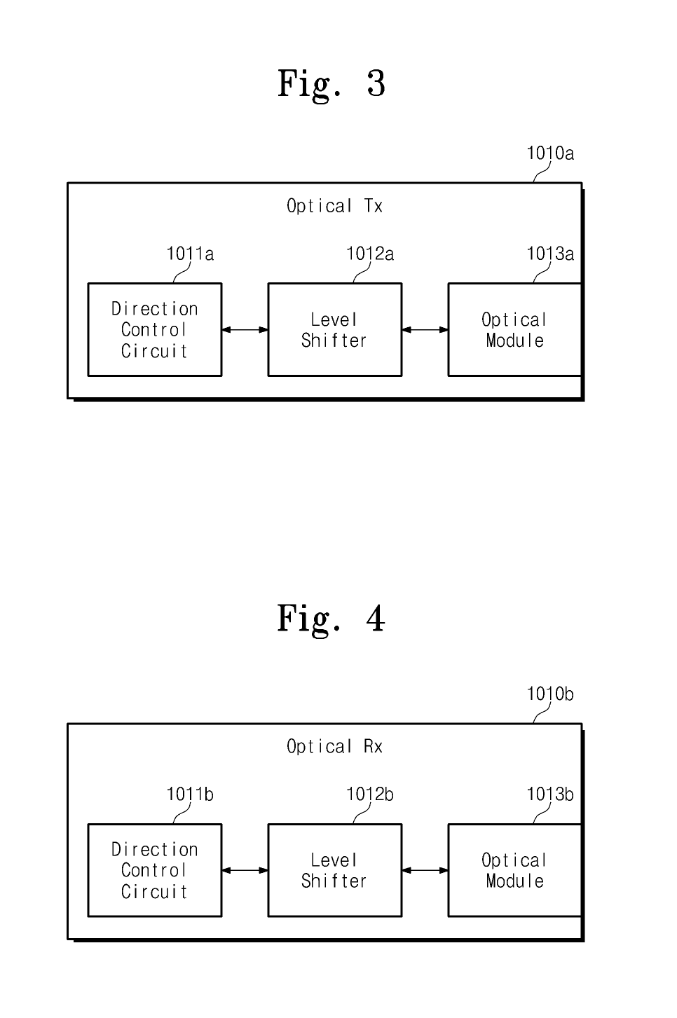

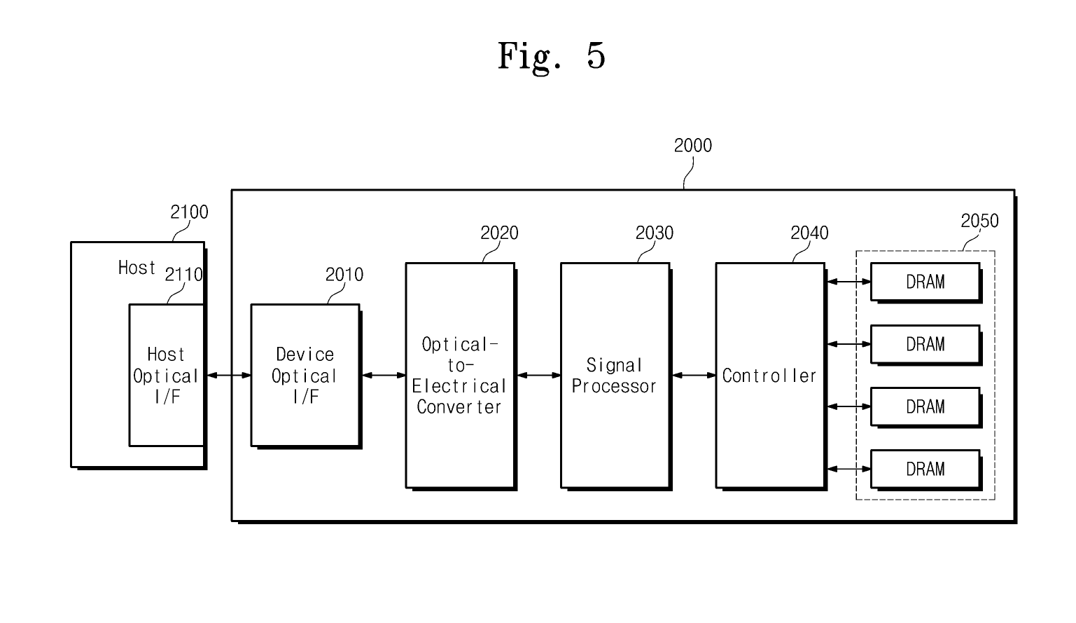

FIG. 3 is a block diagram illustrating the optical transmitter 1010a in FIG. 2, and FIG. 4 is a block diagram illustrating the optical receiver 1010b in FIG. 2. Below, an optical interface connecting manner will be more fully described with reference to FIG. 3 and FIG. 4.

Referring to FIG. 3, the optical transmitter 1010a may include a direction control circuit 1011a, a level shifter 1012a, and an optical module 1013a.

In an Universal Serial Bus (USB) system based on a general electrical signal, upstream data and downstream data may be transferred through the same channel. However, in an Optical Serial Bus (OSB) system, although upstream data and downstream data share the same bus line, upstream data and downstream data must be transferred through different channels.

The direction control circuit 1011a may isolate a data input from the host controller 1020. In detail, the direction control circuit 1011a may separate the data input into upstream data and downstream data to transfer the separated upstream data and downstream data to the level shifter 1012a, so as to drive the optical receiver 1010a normally.

The level shifter 1012a may shift a level of data transferred from the direction control circuit 1011a. A signal level of a driver IC used at the host controller 1020 and the direction control circuit 1011a may be different from that used at the optical module 1013a. The level shifter 1012a may perform a role of matching two signal levels.

The optical module 1013a may convert data adjusted by the level shifter 1012a into an optical signal. The optical module 1013a may include a photo diode for electrical-to-optical conversion. The optical module 1013a may output the converted optical signal to the host optical interface 1140.

With the above description, the optical transmitter 1010a in FIG. 3 may receive data from the host controller 1020 to convert the t data input into the optical signal suitable for transmission.

Referring to FIG. 4, the optical transmitter 1010b may include a direction control circuit 1011b, a level shifter 1012b, and an optical module 1013b. The optical receiver 1010b in FIG. 4 may have a minor symmetrical structure with the optical transmitter 1010a in FIG. 3. An operation of the optical receiver 1010b may be equal to an inversed operation of the optical transmitter 1010a. Below, a difference between the optical receiver 1010b and the optical transmitter 1010a will be described.

Referring to FIG. 4, the optical module 1013b may receive an optical signal from the host optical interface 1140. The optical module 1013b may convert the optical signal into electrical data to transfer it to the level shifter 1012b.

The level shifter 1012b may shift a level of the electrical data from the optical module 1013b to a signal level suitable for the direction control circuit 1011b and a memory controller to send the data to the direction control circuit 1011b. The direction control circuit 1011b may merge data adjusted at the level shifter 1012b to transfer the data to the memory controller.

FIG. 5 is a block diagram illustrating a memory expanding device according to an exemplary embodiment. Referring to FIG. 5, a memory expanding device 2000 may include a device optical interface 2010, and optical-to-electrical converter 2020, a signal processor 2030, a controller 2040, and a volatile memory unit 2050. With this configuration, the memory expanding device 2000 may expand a main memory device of a host 2100 in such a manner that it is installed outside the host 2100.

Like the optical interface 110 in FIG. 1, the device optical interface 2010 may be a signal transfer mean for receiving or transmitting an optical signal. The device optical interface 2010 may be connected with a host optical interface 2110 of the host 2100. The memory expanding device 2000 may transmit and receive an optical signal to and from the host 2100 through the device optical interface 2010.

The device optical interface 2010 may be connected with the optical-to-electrical converter 2020 through an optical transfer path (not shown). The optical transfer path may be implemented by an optical fiber, a wave guide, an optical PCB, or the like. However, the exemplary embodiment is not limited thereto.

The optical-to-electrical converter 2020 may convert an optical signal into an electric signal. In the exemplary embodiments, an optical signal converted at the optical-to-electrical converter 2020 may be an optical signal transferred from the host 2100 through the host optical interface 2110.

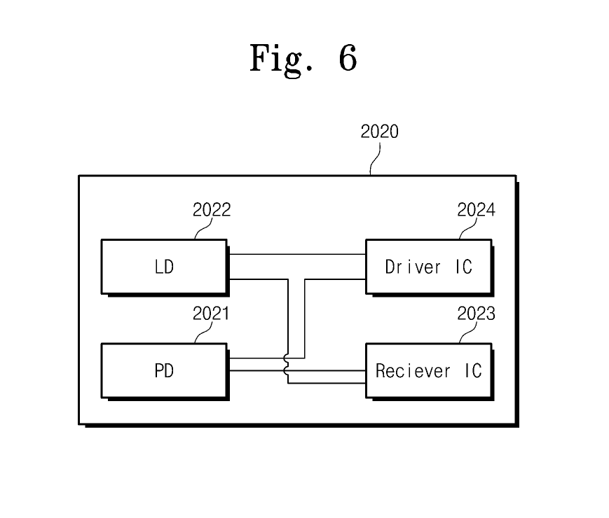

With the above description, the optical-to-electrical converter 2020 may enable electrical signals used at the host 2100 and the memory expanding device 2000 to be exchanged in an optical signal format. Below, the optical-to-electrical converter 2020 will be more fully described with reference to FIG. 6.

FIG. 6 is a block diagram illustrating the optical-to-electrical converter in FIG. 5. Referring to FIG. 6, an optical-to-electrical converter 2020 may include a photo diode 2021, a laser diode 2022, a receiver IC 2023, and a driver IC 2024.

The optical-to-electrical converter 2020 may convert an optical signal into an electrical signal in a high speed using the photo diode 2021 and the receiver IC 2023. The electrical signal converted by the optical-to-electrical converter 2020 may be transferred to the signal processor 2030.

The photo diode 2021 may react to the optical signal to convert the optical signal into the corresponding electrical signal. In the exemplary embodiments, the photo diode 2021 may convert the optical signal transferred from the device optical interface 2010 into the electrical signal.

The receiver IC 2023 may amplify and restore the electrical signal converted by the photo diode 2021. The electrical signal output from the photo diode 2021 may be minute in magnitude. Thus, the electrical signal output from the photo diode 2021 may be amplified for the signal processor 2030 to process an electrical signal reliably.

The receiver IC 2023 may be configured to include a preamplifier and a limiting amplifier. The preamplifier and the limiting amplifier may amplify the electrical signal converted at the photo diode 2021. The preamplifier and the limiting amplifier may prevent noise and crosstalk generated at an amplification operation.

The optical-to-electrical converter 2020 may convert a high-speed electrical signal into an optical signal using the laser diode 2022 and the driver IC 2024. The optical signal converted at the optical-to-electrical converter 2020 may be transferred to the device optical interface 2010.

The laser diode 2022 may react to the electrical signal to convert the electrical signal into the optical signal. In the exemplary embodiments, the laser diode 2022 may convert the electrical signal input from the signal processor 2030 into the optical signal. At this time, the driver IC 2024 may be electrically connected with the laser diode 2022 to drive the laser diode 2022.

The receiver IC 2023 and the driver IC 2024 may be implemented by a silicon chip. The receiver IC 2023 and the driver IC 2024 may have a common function. Thus, the receiver IC 2023 and the driver IC 2024 may be implemented by one transceiver module to share the common function.

As described above, the optical-to-electrical converter 2020 may convert the optical signal transferred from the host 2100 through the device optical interface 2010 into the electrical signal, and may transfer the electrical signal to the signal processor 2030. Also, the optical-to-electrical converter 2020 may convert the electrical signal transferred from the signal processor 2030 into the optical signal, and may transfer the optical signal to the device optical interface 2010. That is, the optical-to-electrical converter 2020 may have a bidirectional conversion function to convert an electrical signal into an optical signal and an optical signal into an electrical signal.

Returning to FIG. 5, the electrical signal converted by the optical-to-electrical converter 2020 may be transferred to the signal processor 2030. The signal processor 2030 may be electrically connected with the optical-to-electrical converter 2020.

The signal processor 2030 may process electrical signals in a split or merge manner. The electrical signal converted into the optical signal at the optical-to-electrical converter 2020 may correspond to a signal which communicates through an optical interface. The converted electrical signal may be converted into an second electrical signal used at a controller 2040 to control a volatile memory unit 2050 through the controller 2040. The signal processor 2030 may convert the electrical signal converted from the optical signal into the second electrical signal complying with a system used at the controller 2040.

The signal processor 2030 may include SerDes (Serializer and Deserializer), a multiplexer, and the like. With this configuration, the signal processor 2030 may split or merge electrical signals. The signal processor 2030 may perform a speed match operation between the electrical signal and the optical signal. With this speed match operation, the signal processor 2030 may modulate the electrical signal to the second electrical signal which is suitable for the controller 2040.

The signal processor 2030 may convert an electrical signal transferred form the controller 2040 into a signal which is suitable for the system which communicates through an optical interface.

The controller 2040 may control the volatile memory unit 2050 in response to the second electrical signal transferred from the signal processor 2030. The controller 2040 may perform a data storing/loading operation on the volatile memory unit 2050 in response to the second electrical signal transferred from the signal processor 2030. There may be illustrated an example that the controller 2040 is included within the memory expanding device 2000. However, a function of the controller 2040 can be performed instead by a central processing unit of the host 2100.

The volatile memory unit 2050 may be a device storing data. The volatile memory unit 2050 may be DRAM or SRAM. However, the exemplary embodiment is not limited thereto. The volatile memory unit 2050 may include a plurality of volatile memories, each of which is controlled by the memory controller 2040. The volatile memories in the volatile memory unit 2050 may be connected in parallel with the memory controller 2040 to be simultaneously accessed by the controller 2040.

In sum, the memory expanding device 2000 according to an exemplary embodiment may be connected with the host 2100 through an optical interface. Information exchanged through the device optical interface 2010 may be transferred in an optical signal format that provides a speed higher than an electrical signal format. Thus, the device optical interface 2010 may provide rapid information exchange between the host 2100 and the memory expanding device 2000.

Also, as described above, the device optical device 2010 of the memory expanding device 2000 may be connected with a host optical interface 2110 of the host 2100. The host optical interface 2110 may be directly connected with a high-speed information processing unit of the host 2100. For example, the host optical interface 2110 may be connected to a north bridge of the host 2100. Alternatively, the host optical interface 2110 may be directly connected with a processor bus or a chipset to be connected with a central processing unit of the host 2100.

Since the memory expanding device 2000 is directly connected with the high-speed information processing unit of the host 2100, information exchange may be performed rapidly. With this configuration, the memory expanding device 2000 may be used as an additional memory device of the host 2100 to expand a main memory of the host.

The host optical interface 2110 of the host 2100 may be implemented by an external interface of the host 2100. Thus, the memory expanding device 2000 may enable a main memory device of the host 2100 to be expanded in an external/removable type.

If expansion of a main memory device is required according to a process is performed by the host 2100, the host 2100 may increase a process speed using the memory expanding device 2000 as a removable/external memory device. If no expansion of a main memory device is required due to completion of the process, the host 2100 may release connection with the memory expanding device 2000. Thus, when expansion of a main memory device is required, the memory expanding device 2000 may be connected with the host 2100 to be used as a main memory device of the host 2100.

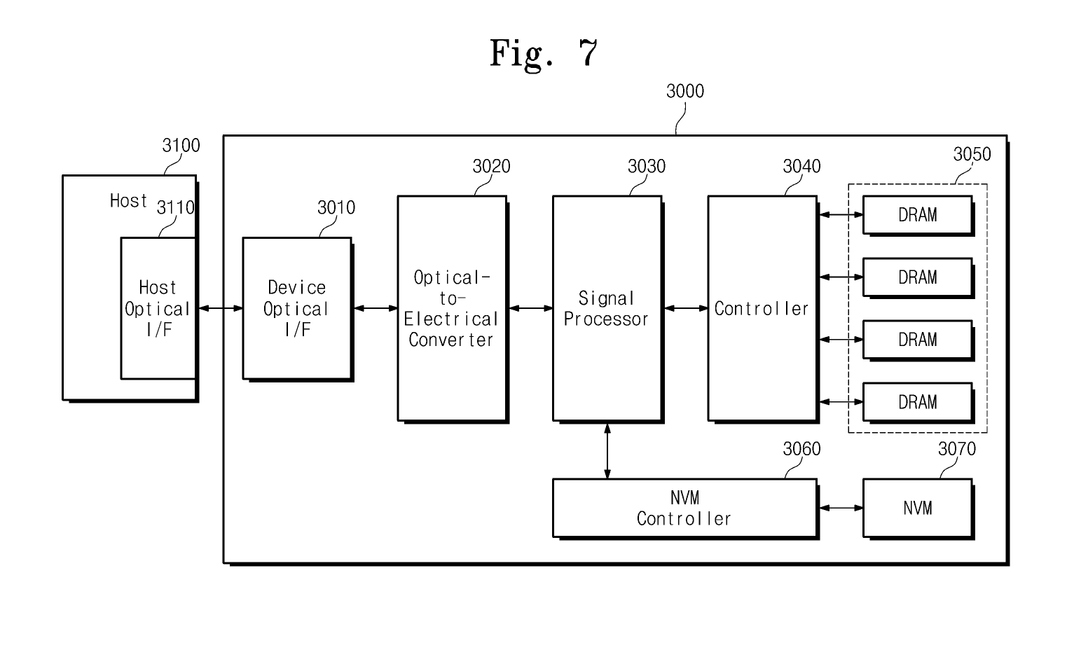

FIG. 7 is a block diagram illustrating a memory expanding device according to an exemplary embodiment. A memory expanding device 3000 in FIG. 7 may be identical to that in FIG. 5 except for a signal processor 3030, a nonvolatile memory controller 3060, and a nonvolatile memory unit 3070, and description thereof is thus omitted.

If an optical signal is transferred from a host 3100 through a device optical interface 3010, an optical-to-electrical converter 3020 may convert the optical signal into an electrical signal.

The signal processor 3030 may convert an electrical signal converted by the optical-to-electrical converter 3020 into the second electrical signal used at a volatile memory controller 3040 and the nonvolatile memory controller 3060. The signal processor 3030 may send the second electrical signal to the volatile memory controller 3040 and the nonvolatile memory controller 3060.

The nonvolatile memory controller 3060 may be electrically connected with the signal processor 3030. The nonvolatile memory controller 3060 may control the nonvolatile memory unit 3070 in response to a signal transferred from the signal processor 3030.

The nonvolatile memory unit 3070 may be a device storing data. The nonvolatile memory unit 3070 may be a Phase Change Memory (PCM), a Magnetic Random Access Memory (MRAM), a Ferroelectric Random Access Memory (FRAM), or a flash memory. However, the inventive concept is not limited thereto.

Since the memory expanding device 3000 includes the nonvolatile memory unit 3070, thus, the memory expanding device 3000 may enable both a main memory device and an auxiliary memory device of a host 3100 to be expanded to be removable from the host 3100.

Since the nonvolatile memory unit 3070 exchanges information with the host 3100 through the device optical interface 3010, it is possible to process information in a rapid speed. With this configuration, the memory expanding device 3000 may provide the host 3100 with an auxiliary memory device having a high processing speed.

The nonvolatile memory unit 3070 may be as a swap memory of the volatile memory unit 3050 according to a fast access with the host 3100 and the volatile memory unit 3050. That is, a processor (not shown) of the host 3100 may swap data stored at the volatile memory unit 3050 at the nonvolatile memory unit 3070.

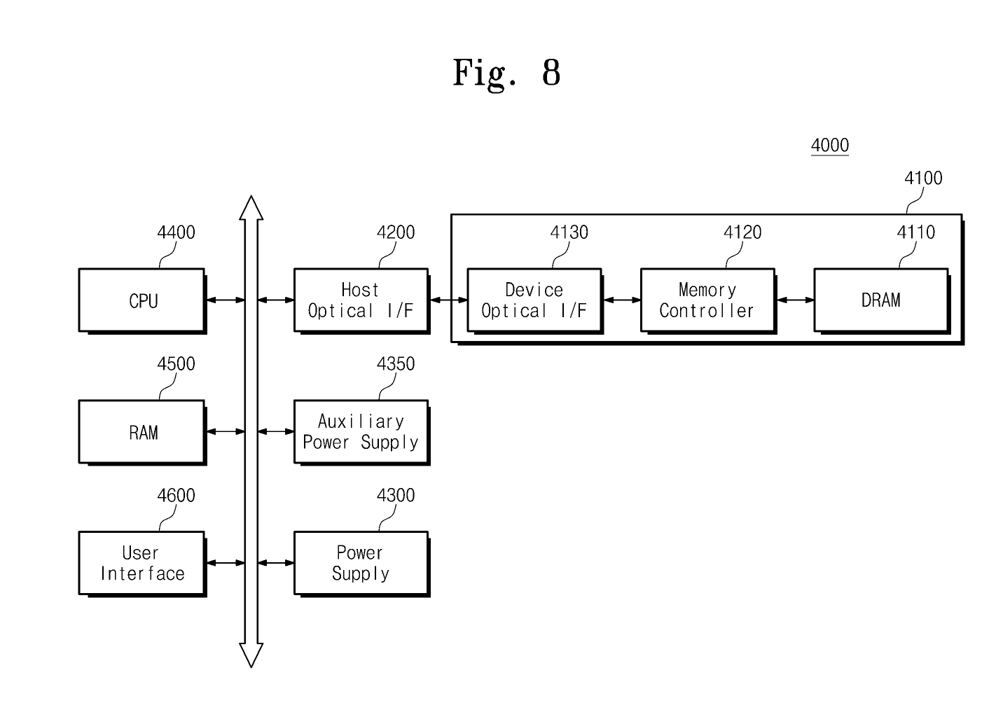

FIG. 8 is a block diagram illustrating an electronic device according to an exemplary embodiment. Herein, an electronic device 4000 may be formed of a personal computer or devices such as a notebook computer, a mobile phone, a camera, and the like.

Referring to FIG. 8, the electronic device 4000 may include a memory expanding device 4100, a host optical interface 4200, a power supply 4300, an auxiliary power supply 4350, a CPU 4400, a RAM (e.g., DRAM) 4500, and a user interface 4600. The memory expanding device 4100 may include a device optical interface 4130, a memory controller 4120, and a volatile memory 4110. The memory expanding device 4100 can be installed at the outside of the electronic device.

As describe above, the electronic device 4000 may expand a main memory device by installing the memory expanding device at the outside through an optical interface. The memory expanding device 4100 may be removable, and may be advantageous to a portable electronic device.

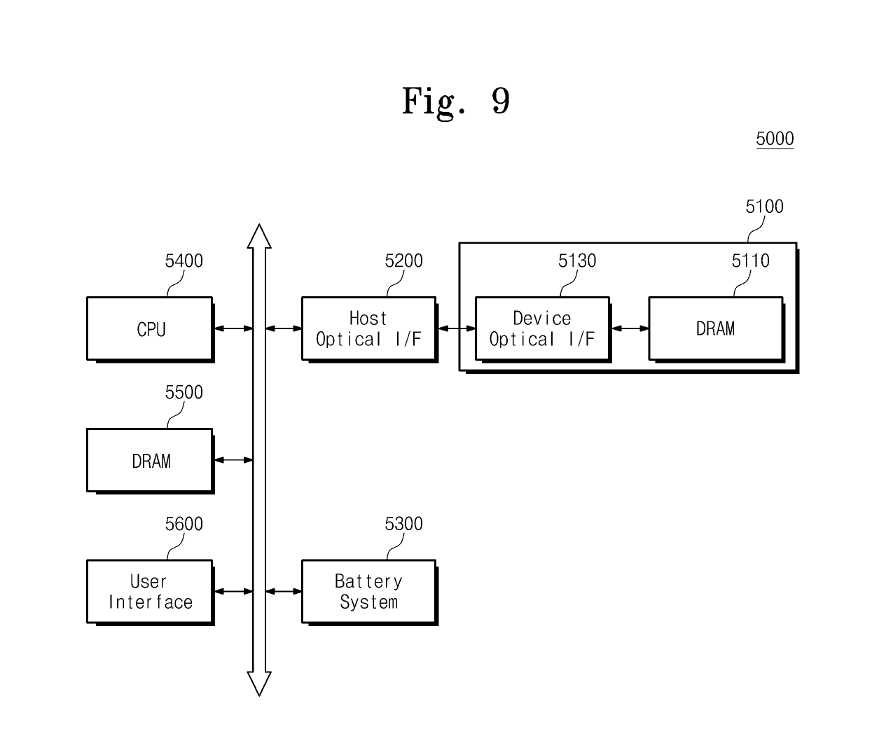

FIG. 9 is a block diagram illustrating an electronic device according to an exemplary embodiment. Herein, an electronic device 5000 may be a handheld electronic device such as a cellular phone, a smart phone, a PDA, or the like.

Referring to FIG. 9, the electronic device 5000 may include a memory expanding device 5100, a device optical interface 5200, a battery system 5300, a CPU 5400, a DRAM 5500, and a user interface 5600. The memory expanding device 5100 may include a device optical interface 5130 and a volatile memory 5110. The memory expanding device 5100 may be installed outside the electronic device 5000.

The CPU 5400 of the electronic device 5000 may control the volatile memory 5110 of the memory expanding device 5100. Thus, data may be written at and read from the volatile memory 5110 of the memory expanding device 5100 without a memory controller.

As describe above, the electronic device 5000 may expand a main memory device by installing the memory expanding device at the outside through an optical interface. The memory expanding device may be removable, and may be advantageous to a portable electronic device such as a smart phone.

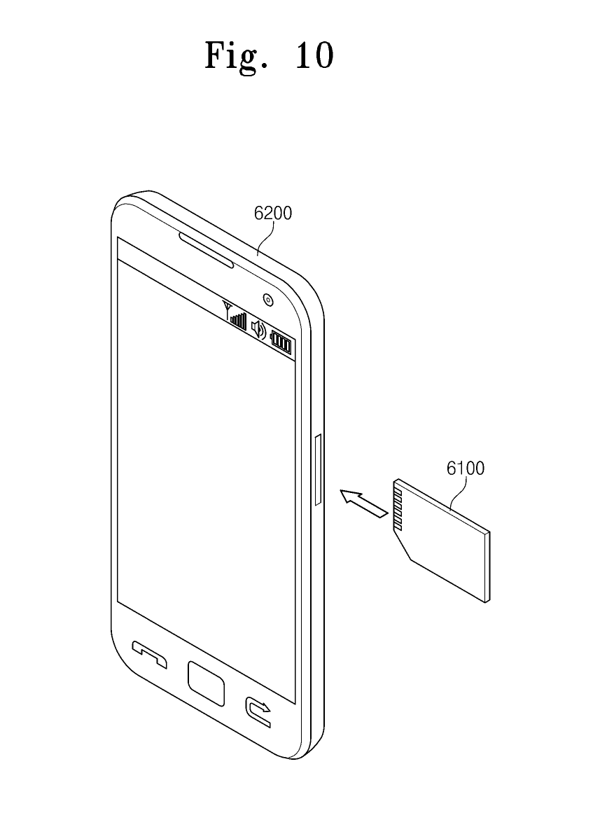

FIG. 10 is a block diagram illustrating an electronic device according to an exemplary embodiment. Referring to FIG. 10, a memory expanding device 6100 may be installed outside a mobile phone 6200.

As describe above, the mobile phone 6200 may expand a main memory device by installing the memory expanding device 6100 at the outside through an optical interface. If expansion of a main memory device is required according to progress of a process, the mobile phone 6200 may increase a process speed using the memory expanding device 6100 as a removable/external memory device. If no expansion of a main memory device is required due to completion of the process, the mobile phone 6200 may release connection with the memory expanding device 6100.

The memory expanding device may be removable, and may be advantageous to a portable mobile phone if the memory expanding device is connected with a mobile phone according to a need for memory expansion. The memory expanding device 6100 may be connected with the mobile phone 6200 through a wire optical interface. Or, the memory expanding device 6100 may be connected with the mobile phone 6200 through a wireless optical interface.

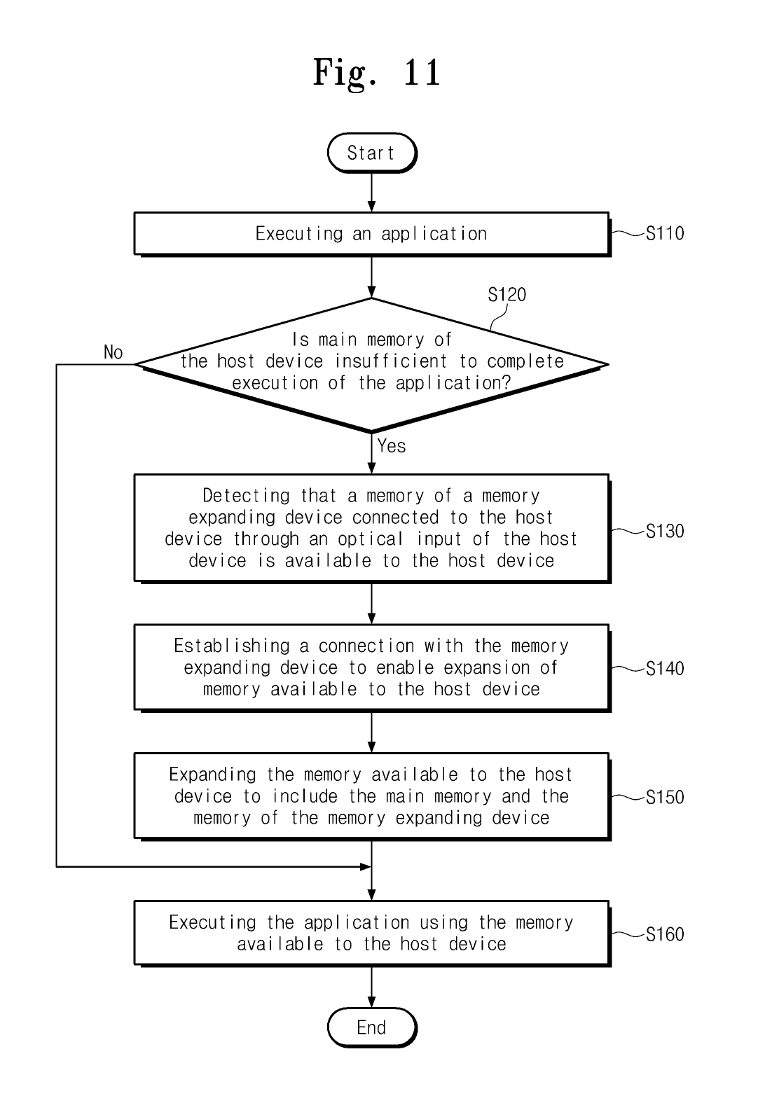

FIG. 11 is a flowchart illustrating a method of expanding memory of a host device to an exemplary embodiment. Referring to FIG. 11, if expansion of memory is required according to progress of a process, the host may expand the memory using the memory expanding device as a removable/external memory device.

In operation S110, an application is executed by a processor of the host device. The data used to execute the application may be loaded into the main memory of the host device.

In operation S120, whether the main memory of the host device is insufficient to complete execution of the application or not is determined. A processor of the host device may determine the insufficiency of the main memory.

If the main memory of the host device determined to be insufficient, in operation S130, a memory of a memory expanding device connected to the host device through an optical input of the host device may be detected by host device. An optical input of the host may be an external interface of the host. That is, the memory expanding device may enable a main memory device of the host to be expanded to be removable from the host.

In operation S140, the host device establishes a connection with the memory expanding device to enable expansion of memory available to the host device. The volatile memory unit of the memory expanding device may enable information exchange with the host to be performed in a high speed. The host device may transmit address signals through the optical interface to control the memory expanding device.

In operation S150, the memory available to the host device is expanded to include the main memory and the memory of the memory expanding device through the connection established in operation S140.

In operation S160, the application is executed using the expanded memory available to the host device. The application may be executed only using the memory of the memory expanding device. Or, application may be executed using the main memory of the host device and the memory of the memory expanding device. the When execution of the application is completed, the connection between the host device and the memory expanding device may be released.

The exemplary embodiments may be modified or changed. For example, an optical interface, an optical-to-electrical converter, a signal processor, a controller, and a volatile memory unit may be changed or modified according to environment and use.

While the inventive concept has been described with reference to exemplary embodiments, it will be apparent to those skilled in the art that various changes and modifications may be made without departing from the spirit and scope of the present invention. Therefore, it should be understood that the above exemplary embodiments are not limiting, but illustrative.

What is claimed is:

1. A memory expanding device, comprising:
an optical interface that transfers an optical signal between the memory expanding device and an external device connected to the memory expanding device through the optical interface;
a memory that stores data; and
a control unit that expands a main memory of the external device to include the main memory and the memory of the memory expanding deice in response to receiving a memory expansion instruction in the optical signal from the external device through the optical interface.

2. The memory expanding device of claim 1 wherein the optical interface comprises:
an optical transmitter that converts an output electrical signal transferred from the control unit into an output optical signal to be transmitted to the external device; and
an optical receiver configured that converts an input optical signal received from the external device into an input electrical signal to be transmitted to the control unit.

3. The memory expanding device of claim 2, wherein the optical transmitter comprises:
a direction control circuit that separates the output electrical signal;
a level shifter that adjusts a level of the separated output electrical signal; and
an optical module that converts the level-adjusted output electrical signal into the output optical signal.

4. The memory expanding device of claim 3, wherein the optical receiver comprises:
an optical module that converts the input optical signal into the input electrical signal;
a level shifter that adjusts a level of the converted input electrical signal; and
a direction control circuit that merges the level-adjusted input electrical signal.

5. The memory expanding device of claim 1, wherein the optical interface comprises:
an optical-to-electrical converter that converts the optical signal transferred from the external device into a first electrical signal; and
a signal processor that converts a signal system of the first electrical signal to generate a second electrical signal,
wherein the control unit controls the volatile memory unit in response to the second electrical signal.

6. The memory expanding device of claim 5, wherein the optical-to-electrical converter comprises:
a photo diode that converts the optical signal into an electrical signal; and
a receiver integrated circuit (IC) that amplifies the electrical signal to generate the first electrical signal.

7. The memory expanding device of claim 6, wherein the receiver IC comprises a preamplifier and a limiting amplifier.

8. The memory expanding device of claim 5, wherein the signal processor comprises a SerDes and a multiplexer.

9. The memory expanding device of claim 5, further comprising:
a nonvolatile memory; and
a nonvolatile memory control unit that controls the nonvolatile memory in response to the second electrical signal.

10. A handheld mobile device, comprising:
a processor;
a main memory;
an optical interface that transfers an optical signal between the handheld mobile device and a memory expanding device connected to the handheld mobile device through the optical interface; and
a controller that transmits to the memory expanding device a memory expansion instruction in the optical signal through the optical interface to expand the main memory of the handheld mobile device to include a memory of the memory expanding device, in response to a command of the processor, wherein the processor controls the memory expanding device to expand the main memory of the handheld mobile device to include the main memory and the memory of the memory expanding device.

11. The handheld mobile device of claim 10, further comprising a high-speed information processing unit that connects the controller to the processor.

12. A handheld mobile system, comprising:
a handheld mobile device; and
a memory expanding device,
wherein the memory expanding device comprises:
an optical that transfers an optical signal between the memory expanding device and the handheld mobile device connected to the memory expanding device through the optical interface;
a memory that stores data; and
a control unit that expands a main memory of the external device to include the main memory and the memory of the memory expanding deice in response to receiving a memory expansion instruction in the optical signal from the external device through the optical interface, and
wherein the handheld mobile device comprises:
a main memory; and
a processor that controls the memory expanding device to expand the main memory of the handheld mobile device to include the main memory and the memory of the memory expanding device.

13. The handheld mobile system of claim 12, wherein the handheld mobile device further comprises an optical interface and a high-speed information processing unit that connects the processor to an optical interface of the handheld mobile device.

14. The handheld mobile system of claim 12, wherein the memory expanding device further comprises:
a nonvolatile memory; and
a nonvolatile memory control unit that controls the nonvolatile memory in response to an optical signal transferred through the optical interface of the memory expanding device.

15. The handheld mobile system of claim 14, wherein the handheld mobile device further comprises a host control unit that controls the volatile memory and the nonvolatile memory such that data stored at the volatile memory is swapped to the nonvolatile memory.

16. A method of expanding memory of a host device, the method comprising:
executing, by a processor of the host device, an application;
determining that a main memory of the host device is insufficient to complete execution of the application;
detecting that a memory of a memory expanding device connected to the host device through an optical input of the host device is available to the host device;
establishing a connection with the memory expanding device to enable expansion of memory available to the host device;
expanding the memory available to the host device to include the main memory and the memory of the memory expanding device; and
executing the application using the expanded memory available to the host device.

17. The method of claim 16, further comprising:
completing execution of the application; and
releasing the connection with the memory expanding device.

18. The method of claim 16, wherein executing the application using the expanded memory comprises executing the application using the memory of the memory expanding device.

19. The method of claim 16, wherein executing the application using the expanded memory comprises executing the application using the main memory and the memory of the memory expanding device.

20. The method of claim 16, wherein the host device transmits address signals through the optical interface to control the memory expanding device.
